(19) United States
(12) Patent Application Publication
(10) Pub. No.: US 2008/0279230 A1
(43) Pub. Date: Nov. 13, 2008

(54) Fabry-perot laser system with phase section, and method of use thereof

(76) Inventor: Mario Dagenais, Chevy Chase, MD (US)

Correspondence Address: ARENT FOX LLP, Suite 400, 1050 Connecticut Avenue, N.W., Washington, DC, 20036-5339, US

(21) Appl. No.: 12/071,686

(22) Filed: Feb. 25, 2008

Related U.S. Application Data
(60) Provisional application No. 60/891,267, filed on Feb. 23, 2007.

(51) Int. Cl. H01S 3/10

(52) U.S. Cl. 372/20

(57) ABSTRACT

A laser having accurately adjustable frequency, the laser including a semiconductor material having a gain region and a phase tuning region, wherein the phase tuning region is coupled to a power source that applies current in order to alter the index of refraction of the phase tuning region. By altering the amount of current applied to the tuning section, the transmission peak of the signal from the laser can be altered.

### CROSS-REFERENCE TO RELATED APPLICATIONS

This application is based upon and claims the benefit of priority from Applicant's prior U.S. Provisional Application No. 60/891,267 titled “Fabry-Perot Laser with Phase Section,” filed on Feb. 23, 2007, the entire contents of which are incorporated herein by reference.

### BACKGROUND OF THE INVENTION

1. Field of the Invention

Aspects of the present invention generally relate to tuning a transmission peak of a laser by integrating a phase tuning region with a gain region in a semiconductor of a laser, for example a Fabry-Perot type laser. The phase tuning region is connected to a power source and current is applied to the phase tuning region thereby altering the index of refraction of the phase tuning region. This changes the overall laser phase and shifts the transmission peak of the signal output by the laser.

2. Background of the Technology

There are a number of applications where it is useful to optically injection seed a slave laser using a master laser.

One application that may involve injection seeding a slave laser through a master laser is in Wavelength-Division Multiplexing-Passive Optical Network (WDM-PON) and other Fiber-to-the-Home (FTTH) type applications. In fiber-optic communications, wavelength-division multiplexing (WDM) is a technology that multiplexes multiple optical carrier signals on a single optical fiber by using different wavelengths of laser light to carry different signals. This multiplies the capacity of a fiber and may enable bidirectional communication over a single strand of fiber. A WDM uses a multiplexer at a transmitter to join the signals together and a demultiplexer at a receiver to split them apart. A Passive Optical Network (PON) is a point-to-multipoint network, in which optical splitters are used to enable a single optical fiber to serve multiple premises. A PON configuration reduces the amount of fiber and central office equipment required compared with point-to-point architectures. Thus, WDM-PON is a type of passive optical networking that uses multiple optical wavelengths to increase the upstream and/or downstream bandwidth available to end users, where one fiber can be used between a central office and a plurality of end users. WDM-PON technology is expensive and is not currently available for use in the homes of average consumers. Typical WDM-PON systems use high cost, distributed feedback lasers.

Although, it may be advantageous to use inexpensive Fabry-Perot laser diodes in an injection seeding arrangement to generate dense wavelength-division-multiplexed (WDM) wavelengths, rather than using more expensive WDM lasers, the wavelength of these types of lasers is typically less accurate than more expensive lasers, and a large amount of optical power may be required to injection lock the slave lasers.

The optical power required for optical injection locking depends on detuning between the master and slave laser. Larger detunings require a larger optical injection level than is required for smaller detunings. In certain applications, the available power for injection locking is limited. There is a need for low cost lasers with a well defined wavelength, or where a wavelength can be accurately selected. If Fabry-Perot type lasers are used, there is a need for a low power method for controlling the transmission peak of a Fabry-Perot laser, for example, in order to reduce the amount detuning between an injected signal wavelength and a slave Fabry-Perot wavelength. A method for minimizing the required optical injection power to injection seed a slave laser using a master laser is needed.

In addition, using injection seeded Fabry-Perot lasers may limit the number of channels that can be injected from a sliced large bandwidth source and may reduce the operating distance of the system.

### SUMMARY OF THE INVENTION

Aspects of the present invention meet the above-identified needs, in addition to other needs, by providing systems including a Fabry-Perot laser having a semiconductor including a gain region and a phase tuning section. The phase tuning section is configured such that a current can be injected into the phase tuning section to alter the index of refraction and thereby tune the transmission peak of an overall cavity of the laser. By applying a particular current to the passive section of the gain region, the transmission peak of the laser can be selected.

This allows a transmission peak to be determined that is closer to resonant with an incident injection seed signal from a master laser. By minimizing the amount of tuning required to injection seed a slave laser, the required optical injected power is also minimized. This makes it more accessible to use injection seeded lasers in applications with only a small amount of power for injection locking. This approach will also permit an increase in the number of channels that can be injected from a sliced large bandwidth source and makes a longer operating distance between a central office and a customer premise possible.

Additional advantages and novel features of aspects of the present invention will be set forth in part in the description that follows, and in part will become more apparent to those skilled in the art upon examination of the following or upon learning by practice thereof.

### BRIEF DESCRIPTION OF THE FIGURES

In the drawings:

FIG. 1 shows a laser system in accordance with an exemplary embodiment of the present invention.

FIG. 2 shows aspects of a semiconductor chip in accordance with an exemplary embodiment of the present invention.

FIG. 3 shows a WDM-PON system in which aspects of the present invention may be applied.

FIG. 4 shows a WDM-PON system in which aspects of the present invention may be applied.

FIG. 5 shows a graph of power requirements for detuning between a master and slave laser.

FIG. 6 shows a graph of power requirements for systems without aspects of the present invention.

### DETAILED DESCRIPTION

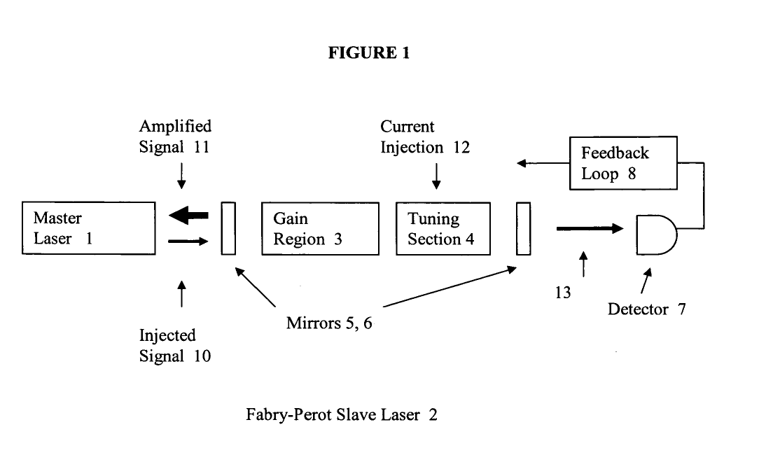

Aspects of an exemplary embodiment of the present invention are disclosed in connection with FIG. 1. FIG. 1 depicts an injection seed application having a master laser 1 that injection seeds a slave laser 2 using an injected signal 10 from the master laser 1. The injected signal 10 is applied to the slave laser 2, causing the slave laser to output an amplified signal 11 of the same wavelength. Thus, slave laser 2 outputs an amplified signal 11 having similar characteristics to the injected signal 10. In one exemplary variation, the master laser and slave laser may both be Fabry-Perot type lasers, laser diodes, or semiconductor lasers. The slave laser cavity includes two reflective surfaces 5, 6, one at each end of a gain region. The reflective surfaces 5, 6 may be, for example, a chip laser facet. The reflective surfaces 5, 6 may include reflective coatings on the surface of a semiconductor in the laser. The semiconductor may be a chip asymmetrically coated with a reflective coating as the reflective surface. For example, the semiconductor may include one facet coated with high reflectivity coating (˜90%) and another other facet coated with a coating having between 1.0-0.1% reflectivity. This ensures that a laser semiconductor chip can be operated at high current, thereby maximizing the gain bandwidth of the laser semiconductor chip.

The slave laser cavity includes a semiconductor having a standard gain region 3 and a phase tuning section 4. The tuning section 4 is configured with a connection to a power supply that selectively applies current 12 to the phase tuning section 4. Although elements 3, 4, 5, and 6 are depicted as separate elements, these elements may all be incorporated in a semiconductor material of a Fabry-Perot type laser.

The tuning section may be, for example, a region in the semiconductor material of the slave laser having a different bandgap energy than the gain region of the semiconductor material. For example, in an exemplary variation, the bandgap energy of the phase tuning section of the semiconductor has a bandgap energy larger than the bandgap energy of the gain region of the semiconductor. When the bandgap energy of the phase tuning section is higher than that of the gain region, the bandgap of the phase tuning section is higher than the energy of the photons generated in the gain region, so that an inversion is not created in the phase tuning section. The phase tuning section may be described in this illustrative operation as “passive” because there is no gain in the phase tuning section. Application of current to the phase tuning section adjusts the index of refraction of the phase tuning section and thus changes the overall laser phase. The application of different levels of current produce different indexes of refraction. Thus, the wavelength of the laser can be accurately selected by applying a particular amount of current to the phase tuning section.

Aspects of the present invention may also include a detector 7 and a feedback loop 8. The detector 7 monitors at least a part of the optical output signal 13 from the slave laser 2. The feedback loop 8 connected between the detector and the phase tuning section 4 assists in the application of the current injection 12 to the phase tuning section 4, in order to obtain the desired signal wavelength. The detector 7 may detect how near resonance the cavity of the slave laser 2 is with the injected signal 10. The feedback loop 8 may also include electronic components to analyze the detected information and adjust the current applied by the current injection feature according to the desired amount of resonance with the injected signal 10.

Even in slave lasers constructed using similar semiconductor materials, different amounts of current may be required in order to select identical cavity resonances. Therefore, the detector and feedback loop provide the ability to determine the amount of current injection required to produce a particular signal from the slave laser.

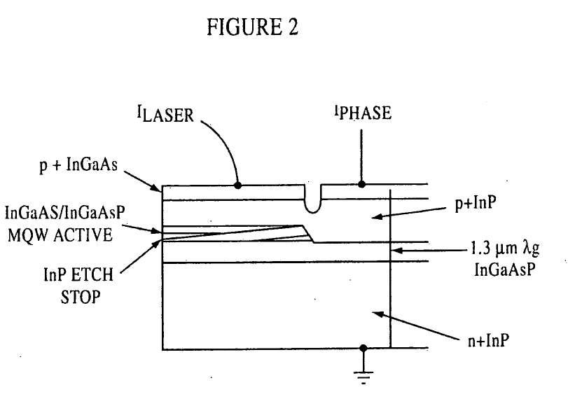

FIG. 2 depicts a layer diagram of a potential epilayer structure semiconductor incorporating a phase tuning section in accordance with an aspect of the present invention. On the left side of FIG. 2, a typical epi-layer of a laser structure of the related art is represented. This epi-layer includes an active region (InGaAs/InGaAsP MQW ACTIVE). On the right side of FIG. 2, the active region is etched away and a wider bandgap material is regrown as the phase tuning region. Using a material with a wider bandgap than the active region ensures the optical transparency of the material. An attachment to a power source is shown on the right side, the phase tuning region of the semiconductor. By injecting current in the phase tuning section, it is possible to change the phase of the overall laser field and adjust the detuning of a slave laser with respect to a master, or injection, laser, as shown in the system in FIG. 1.

As described above, the phase tuning section 4 is a region within a semiconductor material of a slave laser cavity. The phase tuning section may be integrated with the gain region in the semiconductor using, for example, MBE growth technology or MOVPE growth technology, etc. MOVPE allows selective area growth techniques, among others. Both MBE and MOVPE may be used to perform butt-joint regrowth or PARC technology, among others. Those skilled in the art will recognize that other methods of providing a semiconductor material having a higher bandgap along with the lower bandgap, gain region semiconductor material may also be used.

Butt-joint regrowth may include growing an active/gain region semiconductor material, etching at least part of the gain region material, and/or regrowing another semiconductor material having a higher bandgap as the phase tuning section. These two regions will be adjacent each other and will align with each other.

Selective area regrowth may include growing a material with a higher bandgap energy (phase tuning region), and then growing the gain region portion of the semiconductor through an opening in a mask, etc. Among other things, this approach allows the phase tuning section to be grown from the same composition of material as the gain region, because growing the semiconductor material through an opening in a mask increases the rate of growth and lowers the bandgap of the material.

PARC technology may include growing at least two waveguides on top of each other, each waveguide having different bandgap materials. PARC technology is described in U.S. Pat. No. 6,310,995, the contents of which are herein incorporated by reference. PARC permits the monolithic integration of phase tuning and active regions without regrowth. One typical feature of PARC is to epitaxially grow in one step an passive region over a active region. The optical mode can be pushed up-and-down between the two waveguides using vertical resonant couplers. For the phase tuning section, part of the passive region will be etched away and the mode would be pushed up to the passive waveguide, with a higher bandgap than for the active region using resonant couplers. Among other things, the PARC approach avoids the difficulty of regrowth, but may require higher currents because of current spreading.

In FIG. 1, the supply of current 12 to the tuning section 4 changes the index of refraction of the tuning section and thereby changes the overall laser phase and shifts transmission peak of the signal output from the slave laser 2. The overall cavity of the slave laser includes the area between reflective surfaces 5, 6. In general, different levels of current will produce different changes to the index of refraction. It is possible to tune the overall cavity of the slave laser to a desired transmission peak by applying a particular current. Thus, depending on the signal of a master laser, a particular current may be applied to the phase tuning section 4 to provide an overall cavity of the slave laser 2 that is nearly resonant with the incident injection seed signal 10. The required optical injected power of the master/slave laser system is thereby minimized.

A cavity, including the gain region, phase tuning region, and mirrors, of the slave laser may be, for example, less than approximately 500 μm in length. For example, the cavity may be approximately 400-450 μm long. In order to optimize the injection wavelength locking of a Fabry-Perot lasers, it is important to ensure that the narrow-band injected optical signal (wavelength sliced amplified spontaneous emission (ASE)) has a frequency spread that overlaps with at least one Fabry-Perot mode of the laser. If a channel separation of 100 GHz is selected for communication in the FTTH network, then a laser total length of 600 μm, including the phase section, will lead to a longitudinal mode spacing of 0.6 nm. Since a 100 GHz channel spacing corresponds to 0.8 nm, in this example, there would always be a Fabry-Perot laser mode that would overlap with the injected signal. If a channel laser spacing of 50 GHz is adopted, then a total laser length of 1.2 mm is required.

As discussed above, the laser chip may be asymmetrically coated, with one facet coated with high reflectivity coating (˜90%) and the other facet coated with about a 1.0-0.1%, reflectivity coating. This ensures that the laser chip can be operated at high current, thereby maximizing the gain bandwidth of the laser chip. As the current in an optical amplifier is increased, the spectral region where gain can be achieved is appreciably broadened. This result is typically derived because it implies that a narrow band optical signal can be optically injected with good locking efficiency in a mode of the Fabry-Perot laser far away from the medium gain peak. When the laser is modulated at 155 Mb/s, or even at 1 Gb/s, it is thus easier to ensure that the side mode suppression ratio is large (low mode partition noise) so that a bit-error-rate of about 1×10⁻⁹ can be obtained. A gain bandwidth of about 80 nm is desired if the system experiment requires 32 channels. This number was obtained by adding the bandwidth required for 32 channels with 100 GHz spacing (bandwidth=32×0.8 nm=25.6 nm) to the gain peak shift over the required temperature range of operation.

In order to reduce cost, aspects of the present invention may include providing a system without a TE cooler to keep the laser at a constant temperature. Providing a system without a TE cooler and taking a temperature range of operation from −30° C. to 80° C., the gain peak shift can be obtained by multiplying the ΔT=110° C. range by the gain shift temperature coefficient of 0.5 nm/° C. Adding the channel bandwidth required to the temperature shift, a gain bandwidth of about 80 nm can be obtained as required to cover this range.

The length of the cavity should be such that there is only one mode for approximately each 0.2 nm passband of an Arrayed Wave Guide (AWG) because, within the passband, it is beneficial to have not more than one Fabry-Perot peak. Thus, the AWG should have a very defined spacing. For example, the AWG may have a spacing of about 0.8 nm, corresponding to a signal spacing of about 100 GHz. The injected signal may include a superluminescent light source (SLED) injecting the Fabry-Perot lasers. This SLED light source may be a broadband light source with minimum ripple, for example approximately 10 dB ripple.

The system in FIG. 1 may be incorporated into a WDM-PON or other FTTH system. As discussed above, the system in FIG. 1 minimizes the amount of required optical injected power for the master/slave laser system by minimizing the detuning between the master and slave laser, permits longer distances between a central office and a remote user, and allows an increase in the number of channels that can be injected from a sliced large bandwidth source.

The system in FIG. 1 may be incorporated into a WDM-PON system that has lower available power for injection locking, whereas larger detunings between a master and slave laser require a larger optical injection level than would be available in such systems.

One possible system in which the system in FIG. 1 can be incorporated is a WDM-PON system that uses optical injection locking identical Fabry-Perot lasers at all remote Optical Network Unit (ONU) locations. The need for a different laser source (e.g. a wavelength stabilized DFB laser) at each transceiver location has limited the application of WDM-PON systems to the long haul and metro markets, leaving a need in the access area. By using modified wavelength multiplexers/demultiplexers (e.g. cyclic AWGs) that can support multiple wavelengths on each of a plurality of output fibers, a single fiber may provide a bidirectional data link between one central office and a plurality of access users.

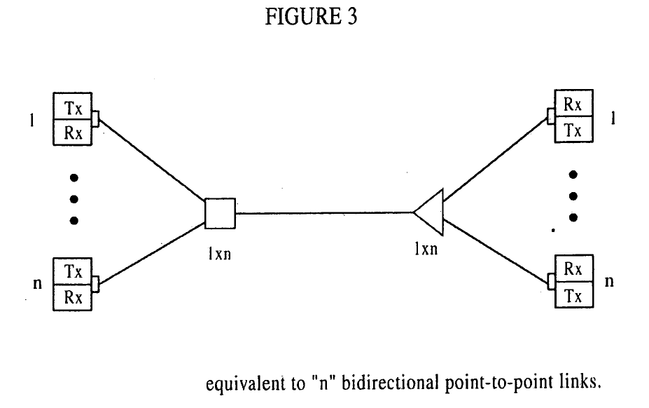

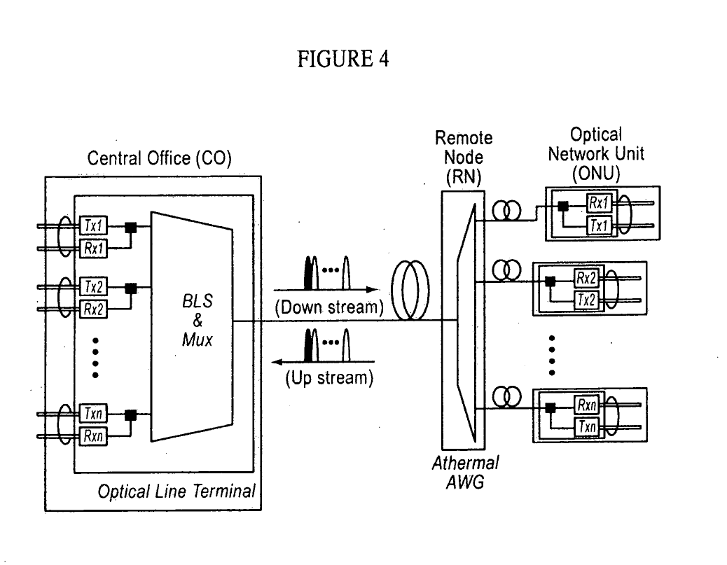

One such exemplary WDM-PON system in accordance with aspects of the present invention will be described in connection with FIG. 3 and FIG. 4. As shown in FIG. 3, such a system may require only single bidirectional data links. In order to separate the signal from the transmitters and the receivers, such an architecture typically requires the use of two wavelength bands, one for upstream traffic and one for downstream traffic. This can be accomplished by using cyclic arrayed-waveguide-gratings (AWGs) that can support multiple wavelengths on each of the corresponding “n” output fibers.

By using automatically wavelength-locked Fabry-Perot laser diodes (FP-LDs), each remote transceiver (transmitter/receiver) in such a system is identical or nearly identical and interchangeable with most other remote transceivers. Identical transceivers are important for minimizing inventory and management costs in an access network. By using athermal AWGs, the remote node can be essentially passive. By using cyclic AWGs, a downstream and an upstream wavelength can be efficiently coupled to each of the remote sites using a single distribution fiber.

An embodiment of a system architecture in accordance with aspects of the present invention is shown in FIG. 4. FIG. 4 shows an un-modulated broadband light source located at an optical line terminal (OLT) in a central office being used to generate the seeding signals for locking a plurality of remotely located Fabry-Perot lasers. The broadband light source is transmitted downstream through the single feeder fiber into the passive remote node containing the cyclic AWG. The spectrum is sliced into “n” channels.

Each spectrally sliced signal is transmitted via a single mode fiber and injected into a remotely located Fabry-Perot. When the Fabry-Perot laser is current modulated with an electrical data signal, a stable narrow-band, quasi single-mode, optical signal is generated by the Fabry-Perot laser. The “DFB”—like signal is automatically aligned to the WDM channel. Simultaneously, “n” independent downstream data wavelengths are transmitted in a different wavelength band.

Because of the cyclic nature of the AWG, both a spectral slice of the broad band source and one downstream data wavelength are multiplexed and sent to each remote optical network unit (ONU). Each ONU transceiver uses an identical or nearly identical filter to separate the two bands, sending one to inject the Fabry-Perot laser and the other into a standard optical receiver. The modulated upstream data signal generated by the wavelength-locked Fabry-Perot laser follows the same path as the downstream broad band seeding source. The wavelength-locked Fabry-Perot lasers are used at both the central office and the remote ONUs. All the ONUs transceivers are identical and can be interchanged. A laser in accordance with aspects of the present invention can be used in each wavelength locked Fabry-Perot laser in the system shown in FIG. 4 in order to reduce the amount of detuning required between an injection (master) laser and a wavelength locked (slave) laser. Among other things, this approach may allow the system to operate with lower optical power, allow an increase in the number of channels that can be injected from the sliced broadband light source, and permit longer operating distances.

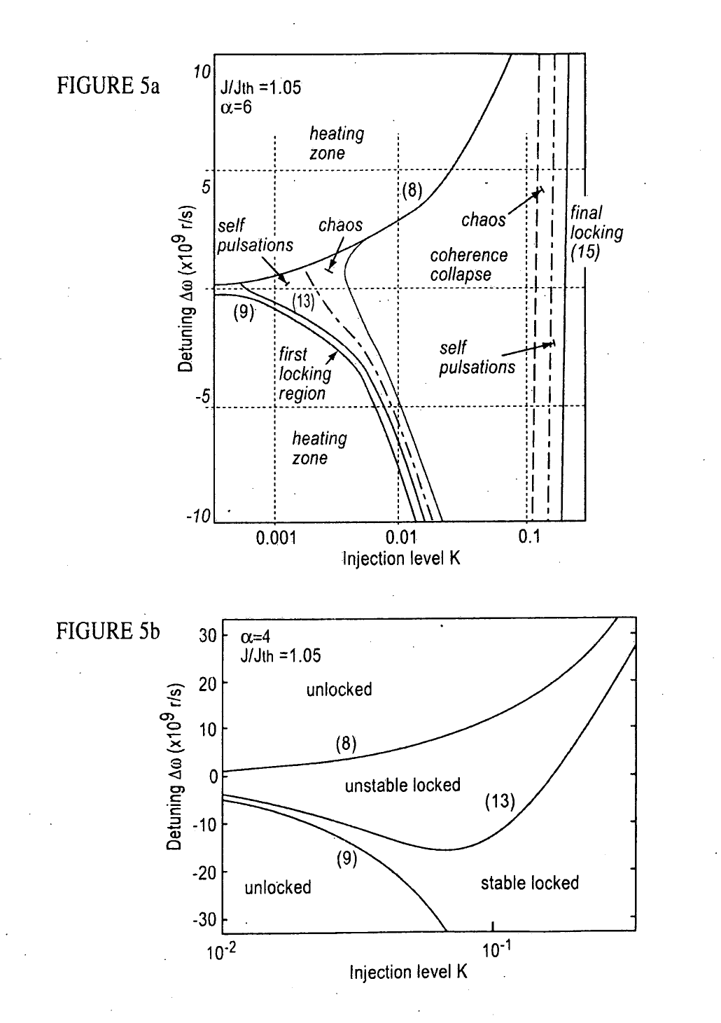

FIG. 5 shows a locking diagram (K, Δω) for a forced oscillator, such as may be used in the system of FIG. 4, in the weak to moderate injection regime. The dynamic behavior and injection locking of a semiconductor laser subjected to external injection generally vary as a function of detuning and the relative amplitude of the injected field K. There may be different typical stability regimes: (a) stable locking regimes, where the slave laser locks in phase to the master laser; (b) a beating regime, where the slave laser is amplitude modulated at the detuning frequency; (c) self-pulsation regimes, where the field of the slave laser oscillates at the relaxation frequency; (d) chaotic regimes, where the oscillation becomes chaotic; and (e) a coherence collapse regime, where the slave laser shows strong fluctuations and its spectrum becomes wide.

FIG. 5 shows that, at low intensity, the stable locking range is very small, in terms of injection locked level for a particular detuning and in the sense that the laser has to be detuned on the negative side. At higher injection levels, section b of FIG. 5 shows that the stable locking range, in terms of the range of injection levels K, is much larger for a particular detuning. Finally, section a of FIG. 5 shows that for high injected intensity, it is always at least theoretically possible to injection lock the slave laser for any detunings. For higher injection currents (e.g. when the slave laser is operated way above threshold), higher optical injection levels are required. This discussion clearly shows that, for the system shown in FIGS. 3 and 4, without a laser in accordance with aspects of the present invention, a high intensity broad band source may be required. For such applications, such a source may be spectrally sliced and each channel used to injection lock a Fabry-Perot laser. By having a phase tuning section on the Fabry-Perot laser in accordance with aspects of the present invention, it may be possible to tune the laser and choose a detuning so as to require a much lower power for obtaining a stable active locking of the Fabry-Perot laser. In this event, the slave laser may therefore be able to operate at higher current injection levels, leading to higher gain in the laser and higher intensity at the output, thereby permitting higher distance coverage.

A Fabry-Perot laser without a phase tuning section to adjust the injection locking of the laser may operate at 150 Mb/s over a temperature range going from −30° C. to 80° C. with a −20 dBm optical injected signal, for example. However, in this case, the modulation current amplitude must increase over the rising temperature to compensate for the laser slope efficiency degradation. At the same time, the bias current of the laser must be actively controlled in a feedback loop to keep the average output power approximately constant at −4 dBm. Aspects of the present invention remove these additional requirements.

In addition, it is beneficial for a system to have data rates of about 1 Gb/s. For example, a 155 Mb/s line typically may not provide sufficient bandwidth for all a number of desired services to be provided to the homes or other locations of consumers, such as streaming video, broadcasting, video-on-demand, internet, video conferencing, etc. Going from 155 Mb/s to 1 Gb/s data rates is not a simple problem to solve using a relatively inexpensive Fabry-Perot laser system and spectrum slice laser injection source, such as is shown in FIGS. 3 and 4. Among other things, this change in data rate will require higher power for both the source and the injection lock laser, unless aspects of the present invention are incorporated in the system. One key problem with using standard Fabry-Perot lasers is that increasing the data rate from 155 Mb/s to 1 Gb/s typically requires increasing the injected optical power by 7 dB. This need may, for example, require using superluminescent sources (SLEDs) producing 150 mW coupled in a fiber. To produce 150 mW in a fiber implies dissipating 15 W, including the TE cooler for the SLED. Appreciably higher power SLEDs would likely be required, given that commercial devices typically have only 60 nm bandwidth and already dissipate 15 W.

It may not be possible to operate several such systems in racks in a provider's central office because, for example, there may be too much heat dissipation. Therefore, there is a need to find a more efficient way to reach the 1 Gb/s operation speed without overly increasing the heat dissipation budget.

Aspects of the present invention may also overcome these problems. For example, a system incorporating aspects of the present invention may require a minimal increase to the injected optical power, because the light may be injected at about the Fabry-Perot laser peak of the slave laser, independently of the surrounding temperature. The phase tuning section according to an aspect of the present invention allows the injection of the light at the Fabry-Perot peak by tuning the Fabry-Perot peak of the slave laser, making the injection very efficient and effectively requiring less injected light than the related art. This translates to a reduction on the power of the spectrally sliced SLED, if operated at 155 Mb/s or to the use of about the same optical injection power at data rates of 1 Gb/s.

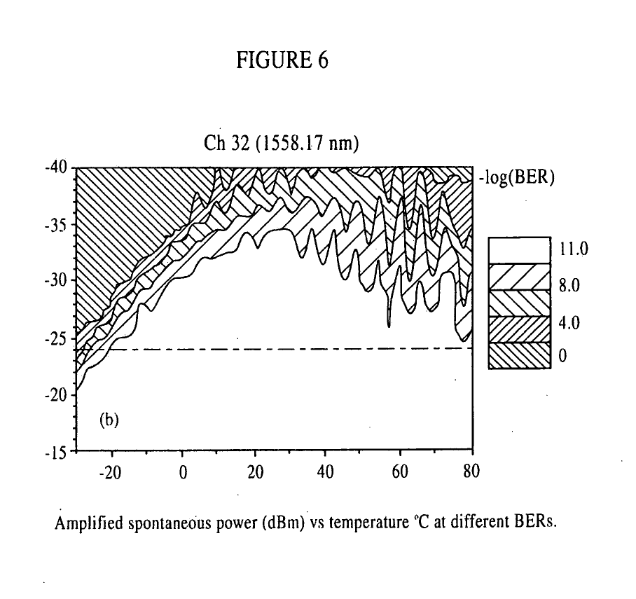

This result can be seen by analyzing in greater details the data shown in FIG. 6. FIG. 6 shows a graph of the amplified spontaneous emission versus temperature at different bit-error-rates (BERs) for data taken at 155 Mb/s, for an exemplary related system without incorporating aspects of the present invention. In this figure, appreciable variation of BER was measured at low temperature for an injection power of −24 dBm. At high temperature, a modulation of BER on the order 5 dB or more is seen. This figure does not include measurements at 1 Gb/s. At such a data rate, it is expected that the required injected power (the y-axis) would need to increase by something on the order of 7 dB. This implies that the Fabry-Perot laser would need to be injected by −13 dBm rather than the −20 dBm that was used. As discussed previously, this power would put too much of a thermal load on the central office, where the SLEDs would be located, absent features, in accordance with aspects of the present invention.

By using a laser according to aspects of the present invention, such that the ASE light is injected at the peak of the Fabry-Perot laser in connection with a very broad band gain bandwidth laser source overcomes these problems. This will remove the large variation of the BER as the temperature is varied and would allow the upgrade of systems such as those depicted in FIGS. 3 and 4.

Example embodiments in accordance with aspects of the present invention have now been described in accordance with the above advantages. It will be appreciated that these examples are merely illustrative of aspects of the present invention. Many variations and modifications will be apparent to those skilled in the art.

1. A laser comprising:
a semiconductor, wherein the semiconductor comprises:
a gain section; and
a phase tuning section;
at least two reflective surfaces; and
a current injection feature coupled to the phase tuning section, wherein the current injection feature is configured to apply current to the phase tuning section, and
wherein the phase tuning section is configured to alter the index of refraction of the phase tuning section when current is applied.

2. The laser according to claim 1, further comprising:
a detector configured to detect the characteristics of a signal generated by the laser.

3. The laser according to claim 2, further comprising:
a feedback device coupled between the detector and the current injection feature.

4. The laser according to claim 1, wherein the laser is a Fabry-Perot type laser.

5. The laser according to claim 4, wherein the semiconductor is configured such that altering the index of refraction by the application of current alters the transmission peak of the Fabry-Perot laser.

6. The laser according to claim 5, wherein the tuning section is configured such that the index of refraction alters depending on the amount of current applied from the current injection feature.

7. A system for providing a desired injection signal wavelength, the system comprising:
a master laser; and
a slave laser, wherein the slave laser includes:
a gain section;
a phase tuning section; and
a current injection feature coupled to the tuning section, wherein the current injection feature is configured to apply a current to the phase tuning section, and wherein the phase tuning section is configured to alter the index of refraction of the tuning section when current is applied.

8. The system according to claim 7, wherein the master is a broadband source having a sliced spectrum and wherein the slave laser is a Fabry-Perot type laser.

9. The system according to claim 8, wherein the slave laser further comprises:
a detector configured to detect the amount of resonance between the slave laser and an injecting signal from the master laser.

10. The system according to claim 9, wherein the slave laser further comprises:
a feedback device coupled between the detector and the current injection feature.

11. The system according to claim 9, wherein the slave laser comprises a cavity, and wherein the slave laser is configured such that an application of a selected current from the current injection feature to the tuning section alters the overall phase of the slave laser.

12. The system according to claim 11, wherein the slave laser is configured such that altering the overall phase of the slave laser by the application of an amount of current alters the transmission peak of the slave laser.

13. The system according to claim 12, wherein the tuning section is configured such that the index of refraction alters depending on the amount of current applied from the current injection feature.

14. A method of phase tuning a slave laser having a gain region and a phase tuning region, the method including:
injecting an injection signal into the slave laser; and
applying an amount of current to the phase tuning section of the slave laser.

15. The method according to claim 14, wherein the slave laser has a cavity, and wherein applying a selected current to the phase tuning section of the slave laser varies the index of phase tuning section of the slave laser.

16. The method according to claim 15, further comprising:
selecting the current such that the cavity of the slave laser has a selected resonance in comparison to the injection signal.

17. The method according to claim 16, further comprising:
detecting the amount of resonance between the injection signal and the cavity of the slave laser via a detector.

18. The method according to claim 17, further comprising:
analyzing the detected amount of resonance at the detector; and
comparing the detected amount of resonance to a desired level of resonance.

19. The method according to claim 18, wherein the injection current is injected from a current injection feature, the method further comprising:
providing feedback to the current injection feature.

20. The method according to claim 19, further comprising:
adjusting the amount of injection current injected to the phase tuning section depending on the provided feedback.
